(19) United States
(12) Patent Application Publication
(10) Pub. No.: US 2015/0020122 A1
(43) Pub. Date: Jan. 15, 2015

(54) MOBILE DEVICE, DISPLAY APPARATUS AND METHOD FOR SHARING CONTENTS THEREOF

(71) Applicant: Samsung Electronics Co., Ltd., Suwon-si (KR)

(72) Inventors: Hyun-jae SHIN, Seoul (KR); Joon-hwan KWON, Suwon-si (KR)

(21) Appl. No.: 14/326,919

(22) Filed: Jul. 9, 2014

(30) Foreign Application Priority Data
Jul. 12, 2013 (KR) 10-2013-0082119

(51) Int. Cl. H04N 21/436; H04N 21/4363

(52) U.S. Cl. CPC H04N 21/43615; H04N 21/43637
USPC 725/81

(57) ABSTRACT

A mobile device, a display apparatus and a method for sharing content thereof are provided. The method for sharing content of the mobile device includes connecting to a display apparatus for communication, receiving a request for content sharing from the display apparatus if the mobile device is verified by the display apparatus, retrieving at least one content, according to a preset condition, from among a plurality of contents stored at the mobile device, and transmitting the at least one retrieved contents to the display apparatus.

### CROSS-REFERENCE TO RELATED APPLICATION(S)

This application claims the benefit under 35 U.S.C. §119(a) of a Korean patent application filed on Jul. 12, 2013 in the Korean Intellectual Property Office and assigned Serial number 10-2013-0082119, the entire disclosure of which is hereby incorporated by reference.

### TECHNICAL FIELD

The present disclosure relates to devices, apparatuses, and methods consistent with what is disclosed herein relate to a mobile device, a display apparatus and a method for sharing contents thereof. More particularly, the present disclosure relates to a mobile device and a display capable of sharing contents stored in at least one mobile device through the display, and a method for sharing contents thereof.

### BACKGROUND

Generally, a home network system is utilized to share media contents including photographs, music, and videos. That is, among a plurality of devices connected to the home network system, a display apparatus plays a role of player, and remaining mobile devices play a role of server. The display apparatus receives a media list from a mobile device and displays the same on screen, and when content is selected from the media list, the mobile device streams the selected content to the display apparatus so that the display apparatus plays the streamed content thereon.

In a related-art home network system, a user himself has to set a connection among the devices to share contents, or select the contents to share by himself. Such is particularly cumbersome for those who are not familiar with handling electronic devices, when setting a connection among devices.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a mobile device and a display apparatus capable of sharing contents stored in at least one mobile device through a display apparatus, while minimizing need for manipulation by a user, and a method for sharing contents thereof.

According to an aspect of the present disclosure, a method for sharing a content of a mobile device is provided. The method includes connecting to a display apparatus for communication, receiving a request for content sharing from the display apparatus if the mobile device is verified by the display apparatus, retrieving at least one content, according to a preset condition, from among a plurality of contents stored at the mobile device, and transmitting the at least one retrieved content to the display apparatus.

According to another aspect of the present disclosure, a mobile device is provided. The mobile device includes a communicator configured to connect to a display apparatus and to perform communication with the display apparatus, a display, a storage configured to store a content, and a controller configured to control the communicator to receive a request for content sharing from the display apparatus if the mobile device is verified by the display apparatus after connecting to the display apparatus via the communicator, to retrieve at least one content according to a preset condition from among a plurality of contents stored at the storage, and to control the communicator to transmit the at least one retrieved content to the display apparatus.

According to another aspect of the present disclosure, a method of a display apparatus for sharing content is provided. The method includes connecting to at least one mobile device for communication upon determining that at least one or more mobile device enters a home where the display apparatus is located, determining whether the at least one connected mobile device is at least one registered mobile device, transmitting a request for content sharing to the at least one registered mobile device, receiving, from the at least one registered mobile device, at least one content, and displaying the at least one content received from the at least one registered mobile device.

According to another aspect of the present disclosure a display apparatus is provided. The display apparatus includes a communicator configured to perform communication with at least one mobile device, a display, and a controller configured to control the communicator to connect to the at least one mobile device for communication upon determining that the at least one mobile device enters a home where the display apparatus is located, to determine whether the at least one connected mobile device is a registered mobile device, to transmit a request for content sharing to the at least one registered mobile device, to control the communicator to receive the at least one content from the at least one registered mobile device, and to control the display to display the at least one content received from the at least one registered mobile device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a contents sharing system according to an embodiment of the present disclosure;

FIG. 2 is a block diagram of a mobile device according to an embodiment of the present disclosure;

FIG. 3 is a detailed block diagram of a mobile device according to an embodiment of the present disclosure;

FIGS. 4 and 5 illustrate a User Interface (UI) provided on a mobile device according to an embodiment of the present disclosure;

FIG. 6 is a block diagram of a display according to an embodiment of the present disclosure;

FIG. 7 illustrates a UI provided on a display according to an embodiment of the present disclosure;

FIG. 8 illustrates a screen displaying contents received at a display according to an embodiment of the present disclosure;

FIG. 9 is a sequence diagram provided to explain a method for sharing contents of a contents sharing system according to an embodiment of the present disclosure;

FIG. 10 is a flowchart provided to explain a method for a mobile device to be connected to a display apparatus according to an embodiment of the present disclosure;

FIG. 11 is a flowchart provided to explain a method for registering a mobile device which is not registered according to an embodiment of the present disclosure;

FIG. 12 is a flowchart provided to explain a method for sharing contents when there are a plurality of people according to an embodiment of the present disclosure;

FIG. 13 is a flowchart provided to explain a method of sharing contents of a mobile device according to an embodiment of the present disclosure; and

FIG. 14 is a flowchart provided to explain a method for sharing contents of a display, according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, same drawing reference numerals are used for the same elements even in different drawings. The matters defined in the description, such as detailed construction and elements, are provided to assist in a comprehensive understanding of the present disclosure. Accordingly, it is apparent that the various embodiments of the present disclosure can be carried out without those specifically defined matters. Also, well-known functions or constructions are not described in detail since they would obscure the disclosure with unnecessary detail.

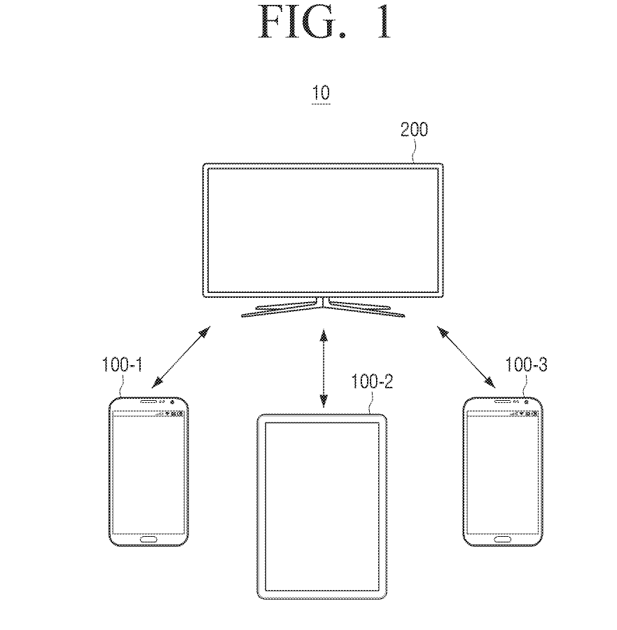

FIG. 1 illustrates a system for sharing contents according to an embodiment of the present disclosure.

Referring to FIG. 1, a contents sharing system 10 includes a plurality of mobile devices 100-1, 100-2, 100-3 and a display apparatus 200. The plurality of mobile device 100-1, 100-2, 100-3 may be implemented as smartphones, tablet Personal Computers (PCs), but are not limited thereto, and may be any similar and/or suitable electronic device. Referring to FIG. 1, the display apparatus 200 may be implemented as a smartphone, but is not limited thereto, and may be any similar and/or suitable electronic device. Accordingly, the display apparatus 200 may be implemented as another displaying device, such as a projection TV, and a monitor.

The plurality of mobile devices 100-1, 100-2, 100-3 determine whether the plurality of mobile devices 100-1, 100-2, 100-3 enter a home where the display apparatus 200 is located. That is, the plurality of mobile devices 100-1, 100-2, 100-3 may determine whether a mobile device 100 enters the home where the display apparatus 200 is located, by using at least one of position information of the mobile device 100, a user context information, movement information of the mobile device 100, network connection information of the mobile device 100, and Near Field Communication (NFC) tagging information. Furthermore, according to an embodiment of the present disclosure, each of the plurality of mobile devices 100-1, 100-2, 100-3 may respectively determine whether each of the plurality of mobile devices 100-1, 100-2, 100-3 enters a home where the display apparatus 200 is located.

When determining that the plurality of mobile devices 100-1, 100-2, 100-3 enter the home where the display apparatus 200 is located, the plurality of mobile devices 100-1, 100-2, 100-3 each connect to the display apparatus 200 for communication. The plurality of mobile devices 100-1, 100-2, 100-3 may connect to the display apparatus 200 using a variety of communication manners and/or systems. For example, the plurality of mobile devices 100-1, 100-2, 100-3 may connect to the display for communication using Wi-Fi communication, Bluetooth communication, or any other similar and/or suitable communication system.

When communication is connected between the plurality of mobile devices 100-1, 100-2, 100-3 and the display apparatus 200, the display apparatus 200 determines whether or not the plurality of mobile devices 100-1, 100-2, 100-3 are registered mobile devices. For example, the display apparatus 200 may determine whether or not the mobile devices belong to family members.

When the mobile device 100-2, from among the plurality of mobile devices 100-1, 100-2, 100-3, is not a registered mobile device, the display apparatus 200 may determine a number of times the mobile device 100-2 is connected and/or has connected to the display apparatus 200, to thus determine whether or not the mobile device 100 belongs to a family member. When the number of times of being connected is equal to or greater than a preset value, the display apparatus 200 may display a message to register the mobile device 100-2. When the mobile device 100-2 is registered according to the message, the display apparatus 200 may verify the mobile device 100-2 and transmit a request signal to the mobile device 100-2 to share contents.

When the mobile device 100-1 and mobile device 100-3, from among the plurality of mobile devices 100-1, 100-2, 100-3, are verified as registered to the display apparatus 200, the display may transmit a request signal to share contents to the mobile device 100-1 and mobile device 100-3.

Then receiving a request signal to share contents, the plurality of mobile devices 100-1, 100-2, 100-3 may each retrieve at least one contents from among a plurality of stored contents according to a preset condition. For example, the plurality of mobile devices 100-1, 100-2, 100-3 may each retrieve at least one of a plurality of contents stored at the mobile device 100, which corresponds to at least one of contents generated during a preset period, contents corresponding to a preset event, contents corresponding to user's feeling, and contents with preset picture quality. The plurality of mobile devices 100-1, 100-2, 100-3 may each retrieve at least one contents from the contents open for sharing, based on the preset condition.

The plurality of mobile devices 100-1, 100-2, 100-3 each transmits the retrieved contents to the display apparatus 200. The display apparatus 200 may display a plurality of contents transmitted from the plurality of mobile devices 100-1, 100-2, 100-3 on one screen.

Accordingly, family members can share the contents on their mobile devices as soon as they come home and without having to separately manipulate the mobile devices.

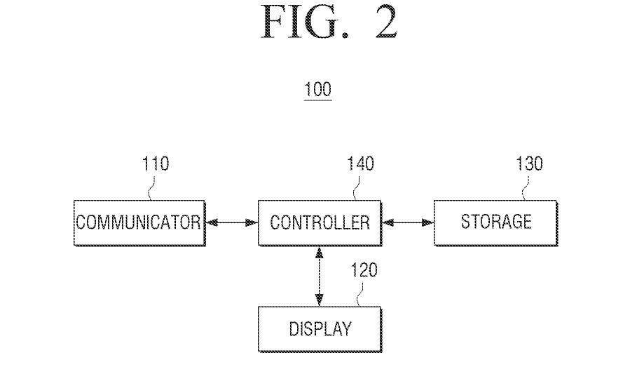

The mobile device 100 according to an embodiment will be explained below with reference to FIGS. 2 to 5.

FIG. 2 is a schematic block diagram of a mobile device according to an embodiment of the present disclosure.

Referring to FIG. 2, the mobile device 100 includes a communicator 110, a display 120, a storage 130, and a controller 140.

The communicator 110 may communicate with the display apparatus 200. That is, if it is determined that the mobile device 100 is within the home where the display apparatus 200 is located, the communicator 110 may perform communication with the display apparatus 200. Further, the communicator 110 receives a request signal for contents sharing from the display apparatus 200 and transmits contents to the display apparatus 200 in response to the request signal for contents sharing.

In an embodiment, the communicator 110 may be directly connected to the display apparatus 200, but the present disclosure is not limited thereto. Accordingly, the communicator 110 may be connected to the display apparatus 200 using a relay device such as a home access point.

The display 120 displays a variety of image data under control of the controller 140. To be specific, the display 120 may display a User Interface (UI) to control power supply of the display apparatus 200. Further, the display 120 may display a message, inquiring as to whether or not to share the contents stored at the mobile device with another user.

The storage 130 stores data and programs to control the mobile device 100. The storage 130 may store various types of contents, e.g., photograph contents, video contents, etc.

The controller 140 controls the overall functions of the mobile device 100. To be specific, the controller 140 determines whether or not the mobile device 100 enters a home where the display apparatus 200 is located. That is, the controller 140 may determine whether or not the mobile device 100 enters the home where the display apparatus 200 is located, using at least one of position information of the mobile device, user context information, movement information of the mobile device, network connection information of the mobile device, and NFC tagging information.

When determining that the mobile device 100 enters the home where the display apparatus 200 is located, the controller 140 may control the communicator 130 to connect to the display apparatus 200 for communication. For example, when determining that the mobile device 100 enters the home where the display apparatus 200 is located, the controller 140 may control the display 120 to display a UI to control the power supply of the display apparatus 200. Then, when a user command to turn on the display apparatus 200 is inputted during an off-period of the display apparatus 200, the controller may transmit a control signal to turn on the display apparatus 200 to the display apparatus 200 and control the communicator 110 to connect to the display for communication.

When the mobile device 100 is connected to the display apparatus 200 via the communicator 110 and verified by the display apparatus 200, the controller 140 controls the communicator 110 to receive a request for contents sharing from the display apparatus 200.

Meanwhile, when determining that another user is in the home where the display apparatus 200 is located, the controller 140 may control the display 120 to display a message to inquire as to whether or not to share the contents stored at the mobile device 100 with the other user.

The controller 140 may retrieve at least one of the plurality of contents stored at the storage 130 according to a preset condition. That is, the controller 140 may retrieve at least one of the plurality of contents stored in the storage 130 which may be contents generated during a preset period, contents corresponding to a preset event, contents corresponding to user's feeling, and/or contents with a preset picture quality. For example, the controller 140 may exclusively retrieve the photograph contents that were taken today or during trip to Jeju island. The controller 140 may retrieve the contents that include open information and that meet preset condition.

The controller 140 controls the communicator to transmit the at least one retrieved content to the display apparatus 200.

With the mobile device 100 as explained above, the user is able to share the contents stored at different mobile devices via the display apparatus, without having to input separate manipulation.

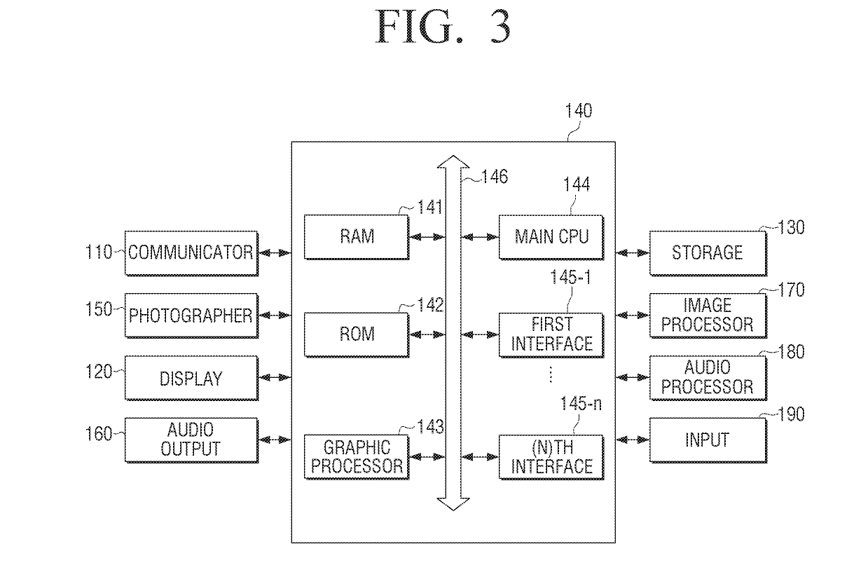

FIG. 3 is a schematic block diagram of a mobile device according to an embodiment of the present disclosure.

Referring to FIG. 3, the mobile device 100 includes the communicator 110, a photographer 150, the display 120, an audio output 160, the storage 130, an image processor 170, an audio processor 180, an input 190, and the controller 140.

Meanwhile, FIG. 3 illustrates a variety of constituent elements, by an example of an apparatus integrating therein a variety of functions including content sharing, communication, video playback, and/or displaying. Accordingly, depending on various embodiments, certain constituent elements displayed in FIG. 3 may be omitted or modified, and/or some other constituent elements may be added.

The communicator 110 is configured to communicate with a variety of external devices according to various types of communication methods and systems. The communicator 110 may communicate with the display apparatus 200, which is an external apparatus, to share contents. The communicator 110 may include various communication chips and/or wireless communication chips, such as a Wi-Fi chip, a Bluetooth chip, a NFC chip, and/or a wireless communication chip. The Wi-Fi chip, the Bluetooth chip, and/or the NFC chip may perform communication in a Wi-Fi, a Bluetooth and/or a NFC manner and/or system. The NFC chip operates in the NFC manner, using 13.56 MHz, among various Radio Frequency (RF) Identification (ID) (RFID) frequency bands, such as 135 kHz, 13.56 MHz, 433 MHz, 860˜960 MHz, and 2.45 GHz. For communication using the Wi-Fi chip and/or the Bluetooth chip, certain connect information, such as a Service Set Identifier (SSID) or session key may be sent first to implement a connection, before transmission and reception of the information. The wireless communication chip refers to chips performing communication under a variety of communication specifications including, for example, Institute for Electrical and Electronics Engineering (IEEE) specifications, Zigbee, Third Generation (3G) specifications, Third Generation Partnership Project (3GPP) specifications, Long Term Evolution (LTE) specifications, and/or any other similar and/or suitable wireless communication specification.

Although not illustrated, the photographer 150 includes a shutter, a lens part, an iris, a charge Coupled Device (CCD) image sensor, and an Analog-Digital Converter (ADC). The shutter, along with the iris, is configured to regulate an amount of light exposed. The lens part receives light from an external light source and processes an image. The iris regulates an amount of light, i.e., luminosity, entering the photographer 150 according to a degree of opening and closing. The CCD image sensor accumulates luminosity, or in other words, accumulates an amount of light, inputted through the lens, conforms an image photographed at the lens part to a vertical synchronous signal according to the accumulated luminosity, and outputs the result. The image acquisition at the image photographing apparatus 100 is performed at the CCD image sensor which converts a light reflected from an object into an electrical signal. In order to acquire a color image with the CCD image sensor, a color filter is used, and to this purpose, a filter called a ‘Color Filter Array (CFA)’ is generally employed. The CFA passes the light corresponding to one color per pixel, has a regularly-aligned structure, and has a variety of forms depending on such alignment structure. The ADC converts an analog image signal outputted from the CCD image sensor into a digital signal.

Meanwhile, the photographer 150 may capture an image in a manner explained above according to one embodiment, or in different manners. For example, instead of CCD image sensor, a Complementary Metal Oxide Semiconductor (CMOS) image sensor and/or any other similar and/or suitable hardware element may be used to capture an image.

The display 120 displays at least one video frame which is obtained by processing image data received from an image receiver (not illustrated) at the image processor 170, and at least one of a variety of screens generated at a graphic processor 143. The display 120 may display a UI to control power supply of the display apparatus 200. Further, the display 120 may display a message to inquire as to whether or not to share the contents stored at the mobile device with another user.

The audio output 160 is configured to output the various audio data processed at the audio processor 180 and also various alarm sounds and/or voice messages.

The storage 130 stores a variety of modules to drive the mobile device 100. For example, the storage 130 may store software (not shown) including a base module, a sensing module, a communication module, a presentation module, a web browser module, and/or a service module. The base module processes a signal transmitted from the hardware of the mobile device 100 and transmits the processed result to an upper-layer module. The sensing module collects information from the sensors, and analyzes and manages the collected information. The sensing module may include a facial recognition module, a voice recognition module, a motion recognition module, and/or an NFC recognition module. The presentation module constructs a display screen, which may include a multimedia module to playback and output multimedia contents, and/or a UI rendering module to perform UI and graphic processing. The communication module is configured to perform external communication. The web browser module refers to a module which accesses a web server by performing web browsing. The service module includes various applications to provide various services.

As explained above, the storage 130 may include a variety of program modules, which may be partially omitted, modified and/or added depending on types and characteristics of the mobile device 100.

The storage 130 may store the photo contents and/or video contents captured at the photographer 150, and also a variety of contents types, e.g., music, movie contents, etc. The contents may be stored with open information and/or closed information.

The image processor 170 is configured to process externally-received image data. The image processor 170 may perform image processing on the image data such as decoding, scaling, noise filtering, frame rate conversion, and/or resolution conversion.

The audio processor 180 is configured to process audio data. The audio processor 180 may perform processing of the audio data such as decoding, amplification, and/or noise filtering. The audio data processed at the audio processor 180 may be outputted to the audio output 160.

The input 190 receives a user command to control the overall operation of the mobile device 100. The input 190 may be implemented as a touch screen, but is not limited thereto. For example, the input 190 may be implemented as other forms of input apparatus such as a mouse, a keyboard, and/or the like.

The controller 140 controls the overall operation of the mobile device 100 using the programs stored at the storage 130.

Referring to FIG. 3, the controller 140 includes a Random Access Memory (RAM) 141, a Read-Only Memory (ROM) 142, the graphic processor 143, a main Central Processing Unit (CPU) 144, first to (n)th interfaces 145-1˜145-n, and a bus 146. The RAM 141, the ROM 142, the graphic processor 143, the main CPU 144, and the first to (n)th interfaces 145-1˜145-n may be connected to each other via the bus 146.

The ROM 142 stores a command set to boot up the system and/or the mobile device 100. When power is supplied according to a turn-on command as inputted, according to the stored command, the main CPU 144 copies an Operating System (OS) stored at the storage 130 onto the RAM 141, and boots up the system. When booting is completed, the main CPU 144 copies application programs stored at the storage 130 onto the RAM 141, and runs the application programs copied onto the RAM 141 to perform intended operations.

The graphic processor 143 generates a screen including a variety of objects such as icons, images, and/or texts, using a calculator (not illustrated) and a renderer (not illustrated). Using the control command received from the input 190, the calculator calculates attributes such as coordinates, forms, sizes and/or colors according to which each object is to be displayed, according to a screen layout. The renderer generates a screen including an object therein in various layouts, based on the attributes calculated at the calculator. The screen generated at the renderer is displayed within a display area of the display 120. The graphic processor 143 may generate a UI which includes a video-containing feed.

The main CPU 144 accesses the storage 130 and performs booting, using the OS stored at the storage 130. The main CPU 144 performs a variety of operations using the programs, contents and/or data stored at the storage 130.

The first to (n)th interfaces 145-1˜145-n are connected to the components explained above. One of the first to (n)th interfaces 145-1˜145-n interfaces may be a network interface which is connected to an external device through a network.

When the mobile device 100 is verified by the display apparatus 200 after connecting thereto via the communicator 110, the controller 140 may control the communicator 110 to receive a request for content sharing from the display apparatus 200. The controller 140 may retrieve at least one content from the plurality of contents stored at the storage 130, according to a preset condition, and control the communicator 110 to transmit the retrieved content to the display apparatus 200.

Specifically, the controller 140 may control the communicator 110 to perform a connection to the display apparatus 200 for communication. The controller 140 may control the communicator 110 to connect to the display apparatus 200 for communication when determining that the mobile device 100 is located within a home where the display apparatus 200 is located. The controller 140 may determine whether or not the mobile device 100 enters the home where the display apparatus 200 is located, using at least one of position information of the mobile device 100, user context information, movement information of the mobile device, network connection information of the mobile device, and NFC tagging information.

For example, the controller 140 may determine whether or not the mobile device 100 is in the home where the display apparatus 200 is located, using Global Positioning System (GPS) information acquired via a GPS module (not illustrated), and/or position information of the mobile device 100, such as a cell ID of a base station to which the mobile device is currently connected. The controller 140 may determine whether or not the mobile device 100 is at home, using a plurality of pieces of position information in sequence. For example, since the mobile device 100 constantly receives and stores the cell ID, the controller 140 may first determine whether or not the mobile device 100 accesses a base station nearby home, using the cell ID. When determining that the mobile device 100 accesses the base station nearby a pre-stored home, the controller 140 may turn on the GPS module to receive GPS information and determine whether or not the mobile device 100 is in the home where the display apparatus is located.

Further, the controller 140 may determine whether or not the mobile device 100 is in the home where the display apparatus 200 is located, using user context information. The user context information refers to information about user's habitual behavior, such as a time when user comes home from work, for example. To be more specific, when the user of the mobile device 100 generally comes home after work at 7 in the evening, the storage 130 stores such time information of 7 in the evening as the user context information, and may determine that the mobile device 100 is present in the home where the display apparatus 200 is located, when it is 7 in the evening.

The controller 140 may also determine whether or not the mobile device 100 is in the home where the display apparatus 200 is located, using movement information of the mobile device 100. In a case where the user stops for a certain period of time for certain act, such as changing shoes, etc., as he enters the home, the controller 140 may determine that the mobile device 100 is in the home where the display apparatus 200 is located when recognizing, through a variety of sensors, such as an accelerometer, a gyro sensor and/or a pressure sensor, the movement information of the mobile device 100 which moves and then stops for a preset period of time.

The controller 140 may determine whether or not the mobile device 100 is in the home where the display apparatus 200 is located using altitude information as measured through a variety of sensors. That is, when the home that the display apparatus 200 is located is on an eighth floor of an apartment building, the mobile device 100 may store in advance altitude information about the eighth floor of the apartment building. Accordingly, when the altitude sensor and/or pressure sensor acquires altitude information and the acquired altitude information matches the pre-stored altitude of the eighth floor, the controller 140 may determine that the mobile device 100 is in the home where the display apparatus 200 is located.

Further, the controller 140 may determine whether or not the mobile device 100 is in the home where the display apparatus 200 is located, using magnetic field information measured through a geomagnetic sensor. That is, the natural magnetic field of the earth is distorted in a building due to presence of building structures and/or electronic appliances. Because the degree of magnetic field distortion varies inside the building depending on locations, unique earth magnetic fields may be detected at respective locations. Accordingly, the controller 140 may determine earth magnetic field value of an area where the mobile apparatus 100 is located, using the geomagnetic sensor. The controller 140 may measure the earth magnetic field value by calculating |Z|, |H|, D, by:

|Z|=((sin α*X′)̂2+(sin β*Y′)̂2+2(cos α*cos β*Z′)̂2)̂0.5

|T|=((X′)̂2+(Y′)̂2+(Z′)̂2)̂0.5

I=sin−1(|Z|/|T|)

|H|=|T|*cos(I)

D=tan−1(Y/X) [symbol] Mathematical expression 1

[symbol]

wherein, X′ denotes a shorter screen width on a plane horizontal to the screen, Y′ is a longer width on a plane horizontal to the screen, and Z′ is a perpendicular direction to the screen.

The controller 140 may calculate the earth magnetic field value in the manner explained above. When the calculated earth magnetic field value matches unique earth magnetic field value in the home where the display apparatus 200 is located, the controller 140 may determine that the mobile device 100 is in the home where the display apparatus 200 is located.

The controller 140 may determine whether or not the mobile device 100 is in the home where the display apparatus 200 is located using network connection information of the mobile apparatus 100. That is, the controller 140 may determine whether or not the mobile device 100 is in the home where the display apparatus 200 is located, using information of an access point, e.g., a Media Access Control (MAC) address, etc., where the communicator 110 is currently connected.

The controller 140 may also determine whether or not the mobile device 100 is in the home where the display apparatus 200 is located using NFC tagging information. That is, the controller 140 may determine whether or not the mobile device 100 is in the home where the display apparatus 200 is located when the NFC module is at a preset space of the home, as the user performs NFC tagging to the preset space of the home.

Although some examples of determining whether or not the mobile device 100 is in the home where the display apparatus 200 is located have been explained above, the various embodiments are not limited thereto. For example, it is possible to determine whether or not the mobile device 100 is in the home where the display apparatus 200 is located using a combination of at least two pieces of the information.

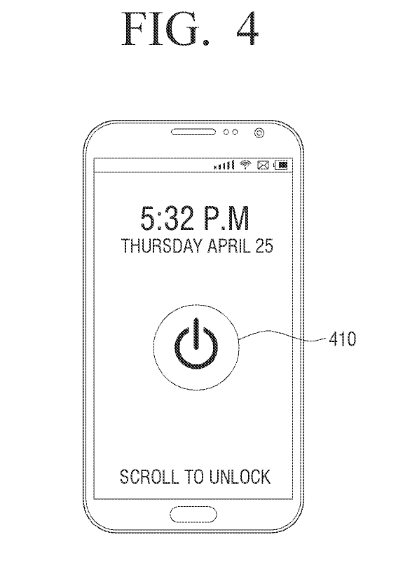

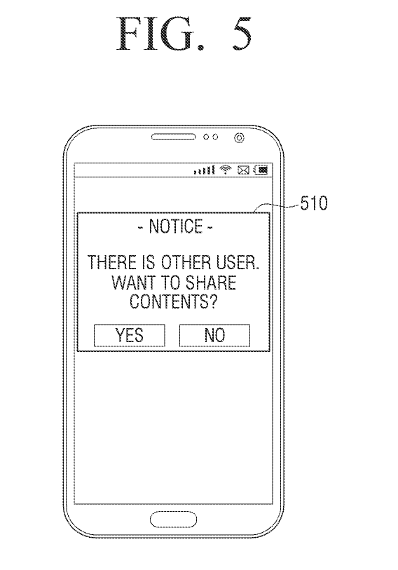

FIGS. 4 and 5 illustrate a UI provided on a mobile device according to an embodiment of the present disclosure.

Referring to FIGS. 4 and 5, when the mobile device 100 determines that the mobile device 100 is in the home where the display apparatus 200 is located, the controller 140 controls the communicator 110 to communicate with the display apparatus 200. The controller 140 may communicate with the display apparatus 200 in a variety of manners. For example, the controller 140 may determine whether or not the Wi-Fi module is on, when determining that the mobile device 100 is in the home where the display apparatus 200 is located during a period the display apparatus 200 is connected to the home access point. When determining that the Wi-Fi module is on, the controller 140 may communicate with the home access point based on the information thereof stored at the storage 130, e.g., the MAC address, etc. However, when the Wi-Fi module is not on, the controller 140 may automatically turn the Wi-Fi module on, and perform communication with the home access point based on the information of the home access point stored at the storage 130, e.g., the MAC address, etc. Referring to FIG. 4, the controller 140 may also control the display 120 to display a UI 410 on a lock screen to control power supply of the display apparatus 200, to enable the mobile device 100 connected to the home access point to control the power supply of the display apparatus 200. When a user command is inputted to select the UI 410 during an off-period of the display apparatus 200, the controller 140 may control the communicator 110 to transmit a control command to turn on the display apparatus 200 to the display apparatus 200. Accordingly, the display apparatus 200 is turned on in response to the control command. The controller 140 may connect to the display apparatus 200 connected to the home access point to perform communication.

According to another embodiment, the controller 140 may perform a discovery operation for an electronic apparatus that may be present using the Bluetooth module, and may directly connect to the display apparatus 200 as discovered for communication.

After connecting to the display apparatus 200 for communication, when the mobile device is verified as registered by the display apparatus 200, the controller 140 may control the communicator 110 to receive a request signal for content sharing from the display apparatus 200.

In an embodiment of the present disclosure, the display apparatus 200 may verify the mobile device 100, but the present disclosure is not limited thereto. Accordingly, another device may perform mobile device verification. For example, the mobile device 100 may be verified as to whether the mobile device 100 belongs to a family member or not by another device, such as a home gateway device and/or home access point.

When a request signal for content sharing is received, the controller 140 may retrieve at least one content from among a plurality of contents stored at the storage 130, according to a preset condition. The controller 140 may retrieve at least one of the plurality of contents, which may be contents generated during a preset period of time, contents corresponding to preset event, contents corresponding to user's feeling, and contents with a preset picture quality.

Specifically, from among the plurality of stored contents, the controller 140 may retrieve the content that is generated during a preset period of time. For example, the controller 140 may analyze metadata of a plurality of picture contents stored at the storage 130 and may retrieve only the picture contents that have been taken and generated today.

The controller 140 may also retrieve the content corresponding to a preset event. For example, the controller 140 may determine schedule information of the user stored at the storage 130. When the stored schedule information includes “Trip to Jeju Island”, the controller 140 may analyze the metadata of the plurality of picture contents stored at the storage 130 and retrieve only the picture contents that were taken and generated on the day that corresponds to the “Trip to Jeju Island”.

The controller 140 may retrieve the content that corresponds to user's feeling from among a plurality of contents stored at the storage 130. For example, when user's biological rhythm is down, the controller 140 may retrieve the content related to user's kids' pictures from among a plurality of contents stored at the storage 130.

The controller 140 may also retrieve the content that has a preset picture quality from among a plurality of contents stored at the storage 130. For example, the controller 140 may retrieve only the contents that have been taken with High Definition (HD) resolution or above.

In an embodiment of the present disclosure, the controller 140 may exclusively retrieve the contents that meet the preset condition from among all the contents stored at the storage 130, but the present disclosure is not limited thereto. Accordingly, the controller 140 may exclusively retrieve the contents that meet the preset condition from among some of the contents stored at the storage 130. For example, the controller 140 may retrieve the contents that meet the preset condition from among the contents that are stored at the storage 130 and that have open information. In an embodiment of the present disclosure, the controller 140 may exclusively retrieve the contents that are stored at the storage 130 and that have been filtered out to remove blurry picture contents due to hand shaking. That is, the controller 140 may detect the blurry pictures based on analysis of edge type and sharpness of the picture contents using wavelet transform. Accordingly, the controller 230 may perform wavelet transforms on the incoming image contents, determine if a blur is present by edge type analysis, and determine a degree of blurriness based on sharpness analysis. When determining that the picture content contains a degree of blurriness that exceeds a preset value, the controller 140 may determine that the corresponding picture content is a blurry picture, and thus performs filtering to retrieve only the picture contents that meet the preset condition.

In an embodiment of the present disclosure, at least one content may be selected from among the plurality of contents, in which case the controller 140 may retrieve only the selected content from among the contents stored at the storage 130.

The controller 140 may control the communicator 110 to transmit the at least one retrieved content to the display apparatus 200. Referring to FIG. 5, for privacy protection, when determining, before transmitting at least one content, that there is another user in the home where the display apparatus is located, the controller 140 may display a message 510 to inquire as to whether or not the content stored at the mobile device 100 is to be shared with another user. When it is confirmed that the content is to be shared according to the message 510, the controller 140 may transmit at least one retrieved content to the display apparatus 200.

As explained above, the user shares content with another user on his mobile device 100 without having to separately input manipulation on the mobile device 100.

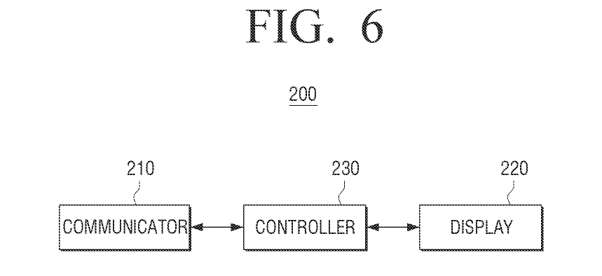

The display apparatus 200 of the contents sharing system 10 will be explained in greater detail below with reference to FIGS. 6 to 8.

FIG. 6 is a schematic block diagram of a display apparatus according to an embodiment.

Referring to FIG. 6, a display apparatus 200 includes a communicator 210, a display 220 and a controller 230. As shown in FIG. 6, the display apparatus 200, in which respective components for functions, such as a content sharing function, a communication function, a video playback function and/or a display function, are integrated according to another embodiment of the present disclosure. Depending on various embodiments, certain components illustrated in FIG. 6 may be omitted or modified, and/or additional components may be provided.

The communicator 210 is configured to communicate with a variety of external devices, e.g., a mobile device such as smartphone and/or a tablet PC according to various types of communication methods. The communicator 210 may communicate with the plurality of mobile devices 100-1, 100-2, 100-3, or any other similar and/or suitable electronic devices, which are external devices, to share contents. The communicator 210 may include various communication chips and/or wireless communication chips, such as a Wi-Fi chip, a Bluetooth chip, a NFC chip, and/or wireless communication chip. The Wi-Fi chip, the Bluetooth chip, and/or the NFC chip may perform communication in Wi-Fi, Bluetooth and/or NFC manner. The NFC chip operates in the NFC manner, using 13.56 MHz, from among various RF-ID frequency bands, such as 135 kHz, 13.56 MHz, 433 MHz, 860˜960 MHz, and 2.45 GHz. For communication using the Wi-Fi chip and/or the Bluetooth chip, certain connection information, such as a SSID and/or a session key, may be sent first to implement a connection, before transmission and reception of the information. The wireless communication chip refers to chips performing communication under a variety of communication specifications including, for example, an IEEE specification, the Zigbee specification, the 3G specification, the 3GPP specification, and/or the LTE specification.

The display 220 outputs image data according to control of the controller 230. The display 220 may display the content received from at least one mobile device. Further, the display 220 may display a message to inquire as to whether or not to share the content.

The controller 230 controls the overall operation of the display apparatus 200. Referring to FIG. 3, when determining that at least one mobile device enters the home where the display apparatus 200 is located, the controller 230 may control the communicator 210 to connect to the at least one mobile device for communication.

The controller 230 may verify whether at least one connected mobile device is a registered device or not. That is, the controller 230 may determine whether the at least one connected mobile device is a registered device using information about the connected mobile device, e.g., a phone number, a MAC address, and/or a SSID.

When there is a registered mobile device among the at least one connected mobile device, the controller 230 may control the communicator 210 to transmit a request for content sharing to the registered mobile device.

When there is a non-registered mobile device among the at least one connected mobile device, the controller 230 may determine a number of times the non-registered mobile device is or has been connected to the display apparatus 200. In an embodiment of the present disclosure, the controller 230 may determine the number of times the mobile device is connected to the display apparatus 200, but the present disclosure not limited thereto. Accordingly, controller 230 may determine the number of times the mobile device 100 is connected to home access point in home.

When the number of times the non-registered mobile device is connected to the display apparatus 200 is equal to or greater than a preset value, the controller 230 may control the display 220 to display a message inquiring as to whether or not to register the non-registered mobile device. The displayed message may include an inquiry as to whether the non-registered mobile device belongs to a family member or not. When a user command directing to register the non-registered mobile device is inputted in response to the message, the controller 230 may verify the newly-registered mobile device. The controller 230 may transmit a request for content sharing to the newly-registered mobile device.

Meanwhile, the controller 230 may determine whether or not there is a plurality of people in the home where the display apparatus 200 is located. The controller 230 may determine whether or not there is a plurality of people in the home where the display apparatus 200 is located by determining a presence of a plurality of people using a camera (not illustrated) provided in the display apparatus 200, and/or by determining whether there is a plurality of devices connected to the home access point of the home where the display apparatus 200 is located.

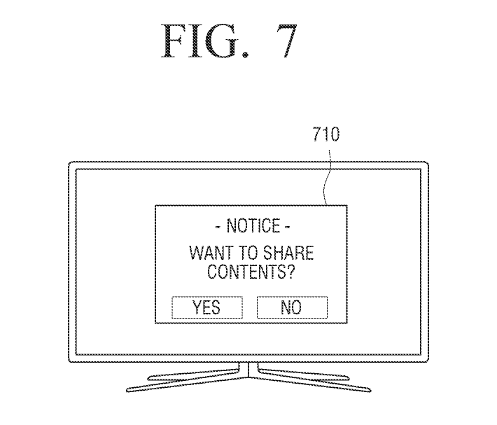

FIG. 7 illustrates a UI provided on a display according to an embodiment of the present disclosure.

Referring to FIG. 7, when determining that there is a plurality of people in the home where the display apparatus 200 is located, the controller 230 may control the display 220 to display an inquiry message 710 as to whether or not to share the content with the plurality of users. When a user command to share the content with the plurality of users is received in response to the message 710, the controller 230 may control the communicator 210 to transmit a request for content sharing to all verified and/or registered mobile devices. However, when a user command not to share the content is inputted in response to the message 710, the controller 230 may control the display 220 to display a list of registered mobile devices. When at least one mobile device is selected from the displayed list, the controller 230 may control the communicator 210 to transmit a request for content sharing to the selected mobile device.

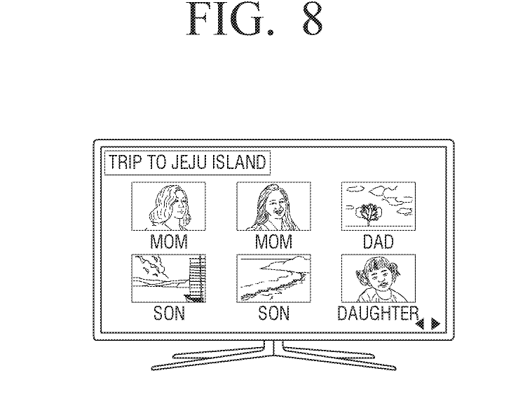

FIG. 8 illustrates a screen displaying contents received at a display according to an embodiment of the present disclosure.

Referring to FIG. 8, when a content is received from at least one mobile device in response to the request for content sharing, the controller 230 may control the display 220 to display the received content. When picture contents are received from a plurality of mobile devices in response to the request for content sharing, the controller 230 may control the display 220 to gather the received picture contents from the plurality of mobile devices, and display the result. The controller 230 may control the display 220 to display information about the mobile devices that transmit the picture contents near the corresponding picture contents.

The controller 230 may play back the received contents and also separate contents. For example, the controller 230 may play music content while displaying the picture contents received from the plurality of mobile devices. The music content may correspond to biorhythms of the user. For example, cheerful music, such as dancing music may be played when the user's biorhythm is down.

The controller 230 may also control an external device while displaying the received content. For example, the controller 230 may control the communicator 210 to transmit a command to an audio device to play music or to an external lighting to adjust brightness, while concurrently displaying the received picture content.

Further, the controller 230 may determine a picture quality of the received picture contents and control the display 220 to display only the picture contents with certain picture quality, or not to display the blurry picture contents. As explained above, the controller 230 may detect the blurry pictures based on edge type and sharpness analysis on the picture contents using wavelet transform. As explained above, the blurry pictures may be prevented from being transmitted from the mobile device 100 and/or be prevented from being displayed even if the blurry pictures are received, but the present disclosure is not limited thereto. That is, blurry pictures may also be received and displayed. The controller 230 may control the display 220 to compensate the blurry pictures using image deblurring before displaying the same.

Accordingly, a user of the mobile device is able to share the content stored at his own mobile device with the other family members through one display apparatus 200.

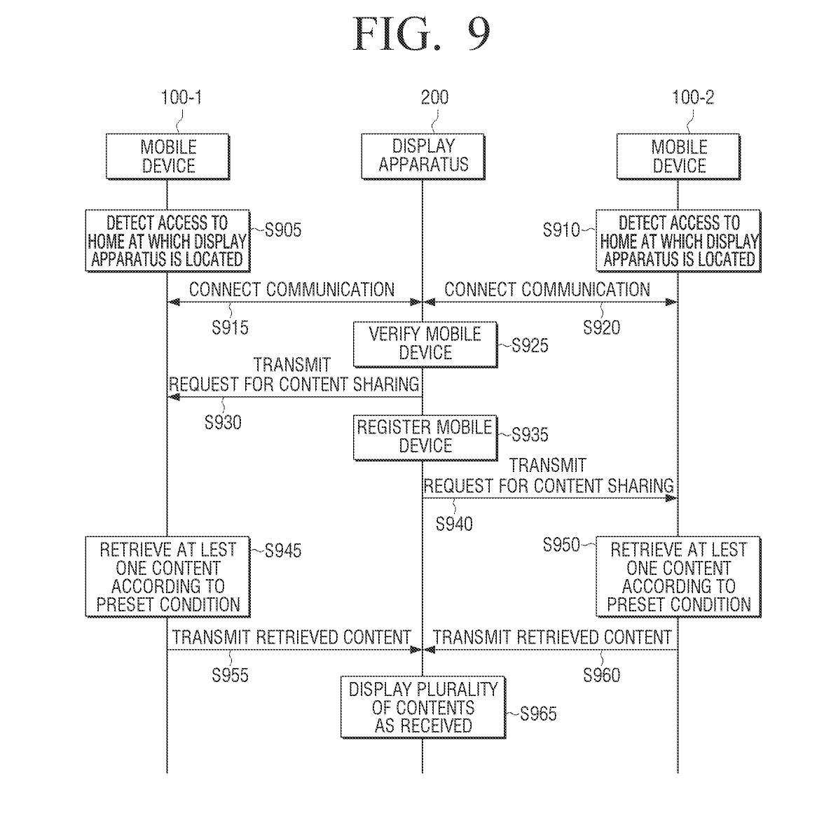

Hereinbelow, a method for sharing contents will be explained with reference to FIGS. 9 to 14.

FIG. 9 is a sequence of a method for sharing contents of a content sharing system 10 according to an embodiment of the present disclosure.

Referring to FIG. 9, at operations S905, S910, a mobile device 100-1 and a mobile device 100-2 detect access to a home at which the display apparatus 200 is located, or in other words, determine whether or not they enter a home where the display apparatus 200 is located. The mobile devices 100-1, 100-2 may determine whether or not they enter a home where the display apparatus 200 is located using at least one of position information of the mobile devices 100-1, 100-2, user context information, movement information of the mobile devices 100-1, 100-2, network connection information of the mobile devices 100-1, 100-2, and NFC tagging information.

When determining that the mobile devices 100-1, 100-2 enter the home where the display apparatus 200 is located, at operations S915, S920, the display apparatus 200 connects to the mobile devices 100-1, 100-2 for communication.

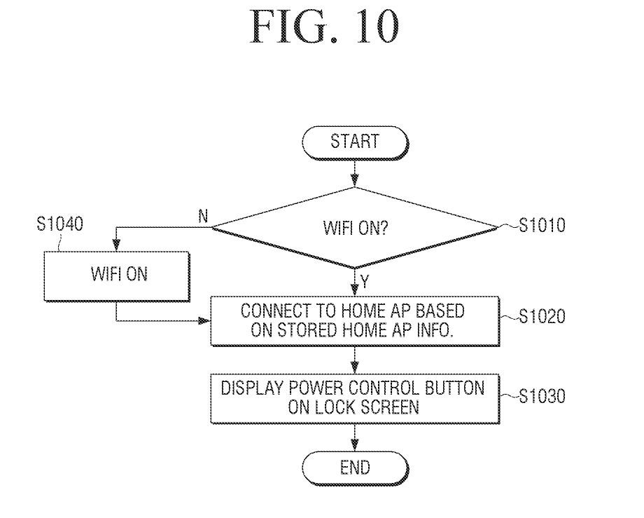

FIG. 10 is a flowchart provided to explain a method for a mobile device to be connected to a display apparatus according to an embodiment of the present disclosure.

Referring to FIG. 10, the method for the display apparatus 200 to connect to the mobile devices 100-1, 100-2 for communication will be explained below with reference to the mobile device 100. At operation S1010, the mobile device 100 determine whether or not a Wi-Fi module is on. After determining that the Wi-Fi module is on in operation S1010, at operation S1020, the mobile device 100 connects to a home access point based on the stored home access point information. After determining that the Wi-Fi module is not on in operation S1010, at operation S1040, the mobile device 100 turns on the Wi-Fi module and connects to the home access point based on the stored home access point information. At operation S1030, the mobile device 100 displays a power supply control button on a lock screen of the display apparatus 200. When the power of the display apparatus 200 is off, the mobile device 100 transmits a power supply control command to the display apparatus 200 upon selection of a power supply control button, as displayed. When the display apparatus 200 is turned on, the mobile device 100 may connect to the display apparatus 200 via the home access point. When the display apparatus 200 is turned on, the mobile device 100 may connect to the display apparatus 200 for communication through the home access point without using additional input.

Referring back to FIG. 9, at operation S925, the display apparatus 200 verifies the mobile device 100.

When the mobile device 100-1 is verified as a registered mobile device, then, at operation S930, the display apparatus 200 transmits a request for content sharing to the mobile device 100-1. However, when the mobile device 100-2 is a non-registered device, then at operation S935, the display apparatus 200 registers the mobile device 100-2.

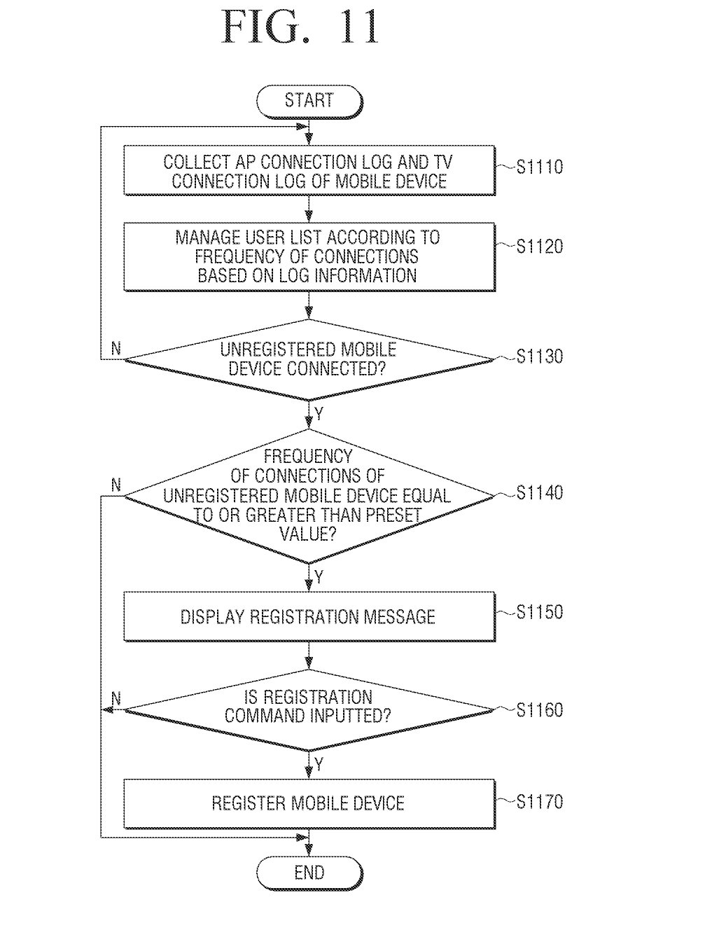

Meanwhile, a method of the display apparatus 200 for registering a non-registered mobile device will be explained below with reference to FIG. 11.

FIG. 11 is a flowchart provided to explain a method for registering a mobile device which is not registered according to an embodiment of the present disclosure.

Referring to FIG. 11, at operation S1110, the display apparatus 200 collects an access point connection log and a TV connection log of the mobile device 100. At operation S1120, the display apparatus 200 manages user list according to a frequency of connections based on the log information. At operation S1130, the display apparatus 200 determines whether or not the non-registered mobile device 100 is connected, and if the non-registered mobile device 100 is connected, then, at operation S1140, the mobile device 100 determines whether or not the frequency of connections of the non-registered mobile device 100 is equal to or greater than a preset value. When the frequency of connections by the non-registered mobile device 100 is equal to or greater than the preset value, then, at operation S1150, the display apparatus 200 displays a registration message. The registration message may include a text that inquires as to whether the non-registered mobile device 100 belongs to a family member. At operation S1160, the display apparatus 200 determines whether or not a registration command is inputted based on the registration message, and if the registration command is inputted, then, at operation S1170, the display apparatus 200 registers the non-registered mobile device 100.

Referring again to FIG. 9, when the mobile device 100-2 is a registered device, then, at operation S940, the display apparatus 200 transmits a request for content sharing to the mobile device 100-2.

After the request for content sharing is received, then, at operations S945, S950, the mobile devices 100-1, 100-2 respectively retrieve at least one content according to a preset condition. That is, the mobile device 100-1 and the mobile device 100-2 may respectively retrieve at least one content from among a plurality of contents stored at the mobile device 100-1 and the mobile device 100-2, in which at least one content may be contents generated during a preset period, contents corresponding to a preset event, contents corresponding to user's feeling, and/or contents with preset picture quality.

At operations S955, S960, the mobile device 100-1 and the mobile device 100-2 may respectively transmit the retrieved contents to the display apparatus 200.

At operation S965, the display apparatus 200 displays a plurality of contents as received from the mobile device 100-1 and the mobile device 100-2.

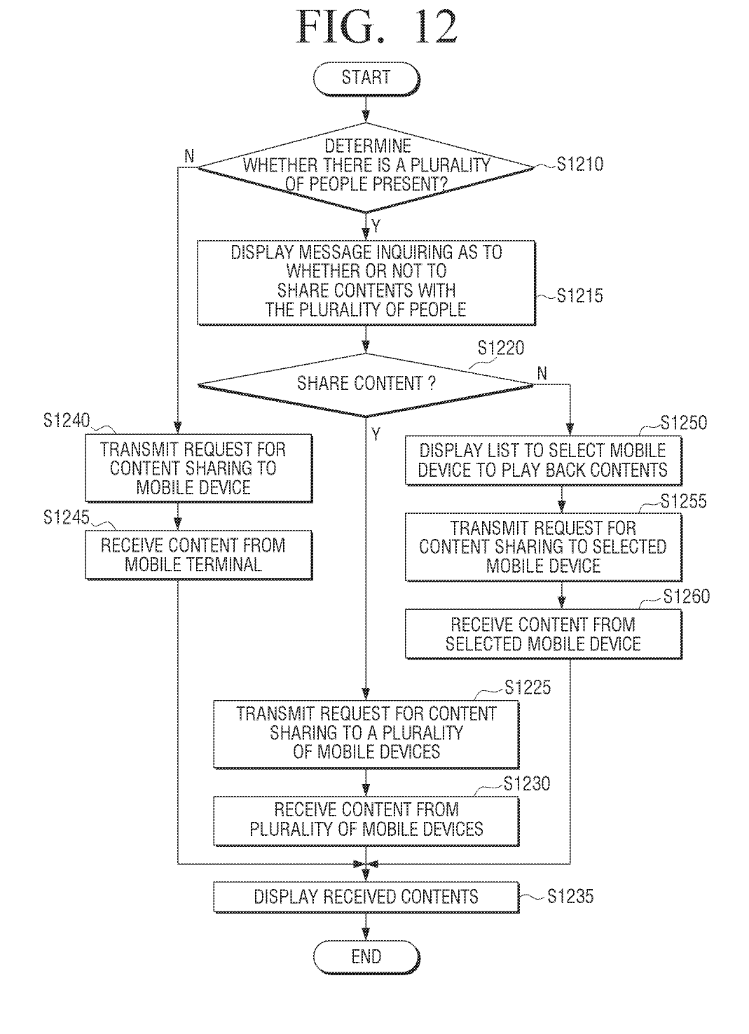

Meanwhile, for privacy protection, when there is more than one user in the home where the display apparatus is located, the display apparatus 200 may inquire as to whether or not to share the content. This will be explained below with reference to FIG. 12.

FIG. 12 is a flowchart provided to explain a method for sharing contents, when there are a plurality of people according to an embodiment of the present disclosure.

Referring to FIG. 12, the display apparatus 200 and the plurality of mobile devices 100-1, 100-2 are connected to each other for communication.

At operation S1210, the display apparatus 200 determines whether there is a plurality of people present. That is, the display apparatus 200 may determine whether there is a plurality of people using a camera provided in the display apparatus 200, and/or by determining whether or not a plurality of devices are connected to an access point present in the home where the display apparatus 200 is located.

If, at operation S1210—Y, the display apparatus 200 determines that there is a plurality of people present, then, at operation S1215, the display apparatus 200 displays a message inquiring as to whether or not to share the contents with the plurality of people.

At operation S1220, the display apparatus 200 determines whether or not to share content based on a user command inputted in response to the inquiry message.

When a user command is inputted, directing the display apparatus 200 to share the contents, then, at operation S1225, the display apparatus 200 transmits a request for content sharing, to share contents, to the plurality of mobile devices. At operation S1230, the display apparatus 200 receives contents from the plurality of mobile devices and at operation S1235, displays the received contents.

On the other hand, if the display apparatus, at operation S1220, determines that a user command is inputted, the user command directing not to share the contents, then, at operation S1250, the display apparatus 200 displays a list to select a mobile device to play back contents, or in other words, a list from which the mobile device to share the contents with the display apparatus 200 is selected.

When at least one mobile device, such as the mobile device 100, is selected from among a plurality of mobile devices, then, at operation S1255, the display apparatus 200 transmits a request for content sharing to the selected mobile device 100, then, at operation S1260, the display apparatus 200 receives content from the selected mobile device 100, and at operation S1235, displays the content received from the selected mobile device 100.

Meanwhile, if the display apparatus 200 determines that there is not a plurality of people present in operation S1210, then, at operation S1240, the display apparatus 200 transmits a request for content sharing to the mobile device 100, then at operation S1245, the display apparatus 200 receives content from the mobile device 100, and at operation S1235, the display apparatus 200 displays the received content.

As explained above, a user's privacy is protected, because possible presence of another user is determined and in that case, the user is inquired as to whether or not he wants to share the contents with the other users.

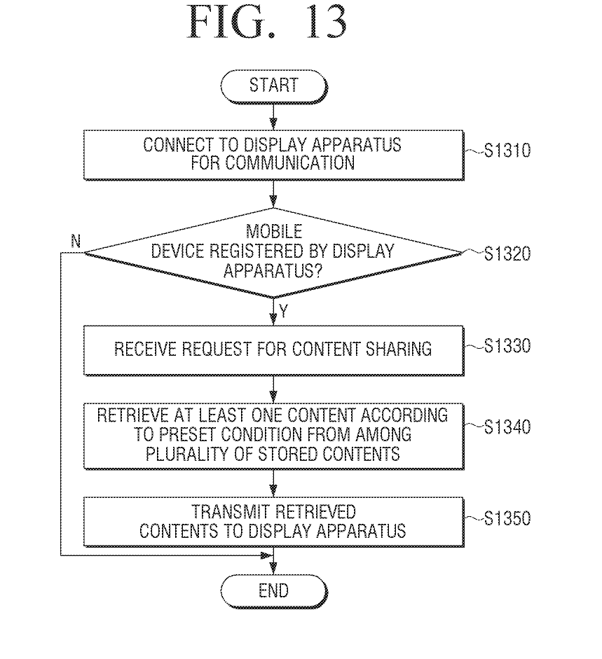

FIG. 13 is a flowchart provided to explain a method of a mobile device to share content according to an embodiment of the present disclosure.

Referring to FIG. 13, at operation S1310, the mobile device 100 connects to the display apparatus 200 for communication. The mobile device 100 may connect to the display apparatus 200 for communication when the mobile device 100 is present in the home where the display apparatus 200 is located.

At operation S1320, it is determined whether the mobile device 100 is registered by the display apparatus 200.

When the mobile device 100 is registered by the display apparatus 200 in operation S1320, then, at operation S1330, the mobile device 100 receives a request for content sharing from the display apparatus 200.

At operation S1340, the mobile device 100 retrieves at least one content according to a preset condition from among a plurality of stored contents. For example, the mobile device 100 may retrieve at least one of the plurality of contents stored at the mobile device 100, in which the content may be contents generated during a preset period, contents corresponding to a preset event, contents corresponding to user's feeling, and/or contents with a preset picture quality.

At operation S1350, the mobile device 100 transmits the retrieved contents to the display apparatus 200.

As explained above, with the mobile device 100 as explained above, the user is able to share certain contents stored at different mobile devices via the display apparatus without having to input separate manipulation.

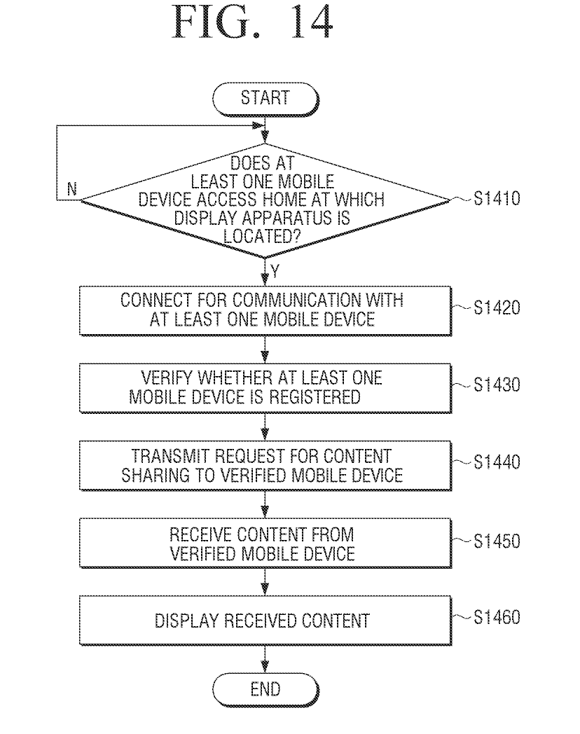

FIG. 14 is a flowchart provided to explain a method for sharing content of the display apparatus according to an embodiment of the present disclosure.

Referring to FIG. 14, at operation S1410, it is determined whether or not at least one mobile device 100 enters and/or access a home at which the display apparatus 200 is located. The possible entrance of the mobile device 100 into a home where the display apparatus 200 is located may be determined using at least one of position information of the mobile device 100, the user context information, movement information of the mobile device 100, network connection information of the mobile device 100, and NFC tagging information.

If it is determined, at operation S1410—Y, that the mobile device 100 enters the home where the display apparatus 200 is located, then, at operation S1420, the display apparatus 200 connects to at least one mobile device 100 for communication.

At operation S1430, the display apparatus 200 verifies whether at least one mobile device, such as the mobile device 100 100, is registered, or, in other words, is a registered mobile device 100.

At operation S1440, the display apparatus 200 transmits a request for content sharing to a verified mobile device, such as the mobile device 100, and at operation S1450, receives content from the verified mobile device, such as the mobile device 100, as a response to the request for content sharing.

At operation S1460, the display apparatus 200 displays the received contents.

As explained above, with the display apparatus 200 as explained above, the users, i.e., family members, are able to share certain contents stored at a plurality of mobile devices, without having to input separate manipulation.

According to the embodiment explained above, when it is determined that mobile device 100 is in the home where the display apparatus 200 is located, the display apparatus 200 may transmit a request for content sharing to the mobile device 100, but the present disclosure is not limited thereto. That is, the display apparatus 200 may transmit a request for content sharing to the mobile device 100 when different conditions are met. For example, the display apparatus 200 may periodically receive schedule information from the mobile devices of the family members and store the received information. When the controller 230 determines that it is a special day such as family member's birthday, wedding anniversary, or planned trip, based on the schedule information, the controller 230 may control the communicator 210 to transmit a request to the mobile device 100 to share picture contents generated in that special day. In an embodiment of the present disclosure, in response to a request from the mobile device 100 of one of the family members to share the picture contents generated on a special day, the controller 230 may control the communicator 210 to transmit the request to the previously registered mobile devices 100 of the other family members to share the picture contents with specific position information, e.g., GPS, etc.

Methods in various embodiments explained above may be implemented as program codes recorded in various types of recording media. For example, the program codes may be recorded on a Random Access Memory (RAM), a flash memory, a Read Only Memory (ROM), an Erasable Programmable ROM (EPROM), an Electronically Erasable and Programmable ROM (EEPROM), a register, a hard disc, a removable disc, a memory card, a Universal Serial Bus (USB) memory, a Compact Disc Read-Only Memory (CD-ROM), and/or a variety of other types of recording media.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for sharing a content of a mobile device, the method comprising:
connecting to a display apparatus for communication;
receiving a request for content sharing from the display apparatus if the mobile device is verified by the display apparatus;
retrieving at least one content, according to a preset condition, from among a plurality of content stored at the mobile device; and
transmitting the at least one retrieved content to the display apparatus.

2. The method of claim 1, wherein the connecting to the display apparatus comprises:
determining whether the mobile device enters a home where the display apparatus is located; and
connecting to the display apparatus for communication upon determining that the mobile device enters the home where the display apparatus is located.

3. The method of claim 2, wherein the determining of whether the mobile device enters the home comprises determining whether the mobile device enters the home where the display apparatus is located using at least one of position information of the mobile device, user context information, movement information of the mobile device, network connection information of the mobile device, and Near Field Communication (NFC) tagging information.

4. The method of claim 2, wherein the connecting to the display apparatus comprises:
displaying a User Interface (UI) to control power supply of the display apparatus upon determining that the mobile device enters the home where the display apparatus is located; and
transmitting a user command to turn on the display apparatus to the display apparatus and connecting to the display apparatus for communication upon receiving a user command to turn on the display apparatus that is inputted through the UI during an off-period of the display apparatus.

5. The method of claim 2, further comprising displaying a message to inquire whether to share the content stored at the mobile device with another user if the mobile device is verified by the display apparatus.

6. The method of claim 1, wherein the retrieving of the at least one content comprises retrieving the at least one contents from among the plurality of content stored at the mobile device,
wherein the plurality of contents includes at least one of content generated during a preset period, content corresponding to a preset event, content corresponding to a user's feeling, and content with a preset picture quality.

7. The method of claim 1, wherein the plurality of contents stored at the mobile device comprises either open information or closed information as set by a user, and
wherein the retrieving of the at least one content comprises retrieving a content that meets the preset condition from among the contents having the open information.

8. A mobile device, comprising:
a communicator configured to connect to a display apparatus and to perform communication with the display apparatus;
a display;
a storage configured to store a content; and
a controller configured to control the communicator to receive a request for content sharing from the display apparatus if the mobile device is verified by the display apparatus after connecting to the display apparatus via the communicator, to retrieve at least one content according to a preset condition from among a plurality of content stored at the storage, and to control the communicator to transmit the at least one retrieved content to the display apparatus.

9. The mobile device of claim 8, wherein the controller is configured to determine whether the mobile device enters the home where the display apparatus is located, and
wherein, the controller is configured to control the communicator to connect with the display apparatus for communication upon determining that the mobile device enters the home where the display apparatus is located.

10. The mobile device of claim 9, wherein the controller is configured to determine whether the mobile device enters the home where the display apparatus is located using at least one of position information of the mobile device, user context information, movement information of the mobile device, network connection information of the mobile device, and NFC tagging information.

11. The mobile device of claim 9, wherein, the controller is configured to control the display to display a User Interface (UI) to control power supply of the display apparatus upon determining that the mobile device enters the home where the display apparatus is located; and
wherein the controller is configured to control the communicator to transmit a user command to turn on the display apparatus to the display apparatus and to connect to the display apparatus for communication upon receiving a user command to turn on the display apparatus that is inputted through the UI during an off-period of the display apparatus.

12. The mobile device of claim 9, the controller is configured to control the display to display a message to inquire whether to share the content stored at the mobile device with another user upon determining a presence of the other user in the home where the display apparatus is located.

13. The mobile device of claim 8, wherein the controller retrieves at least one contents from among the plurality of contents stored at the mobile device,
wherein the plurality of contents includes at least one of content generated during a preset period, content corresponding to a preset event, content corresponding to a user's feeling, and content with a preset picture quality.

14. The mobile device of claim 8, wherein the plurality of contents stored at the mobile device comprises either open information or closed information as set by a user, and
wherein the controller retrieves a content that meets the preset condition from among the contents having the open information.

15. A method of a display apparatus for sharing content, the method comprising:
connecting to at least one mobile device for communication upon determining that the at least one mobile device enters a home where the display apparatus is located;
determining whether the at least one connected mobile device is at least one registered mobile device;
transmitting a request for content sharing to the at least one registered mobile device;
receiving, from the at least one registered mobile device, at least one content; and
displaying the at least one content received from the at least one registered mobile device.

16. The method of claim 15, wherein the determining of whether the at least one connected mobile device is the least one registered mobile device comprises:
determining a number of times a non-registered mobile device is connected to the display apparatus if is the non-registered mobile device is included in the at least one connected mobile device;
displaying a message inquiring whether to register the non-registered mobile device if the number of times the non-registered mobile device is connected to the display apparatus is equal to or greater than a preset value; and
verifying the newly-registered mobile device if the non-registered mobile device is registered in response to the message.

17. The method of claim 15, comprising:
determining whether there is a plurality of people in the home where the display apparatus is located; and
displaying a message inquiring whether to share the at least one content with the plurality of people if there is a plurality of people present in the home where the display apparatus is located.

18. A display apparatus, comprising:
a communicator configured to perform communication with at least one mobile device;
a display; and
a controller configured to control the communicator to connect to the at least one mobile device for communication upon determining that the at least one mobile device enters a home where the display apparatus is located, to determine whether the at least one connected mobile device is at least one registered mobile device, to transmit a request for content sharing to the at least one registered mobile device, to control the communicator to receive the at least one content from the at least one registered mobile device, and to control the display to display the at least one content received from the at least one registered mobile device.

19. The display apparatus of claim 18, wherein, the controller is configured to determine a number of times a non-registered mobile device is connected to the display apparatus when the at least one connected mobile device includes a non-registered mobile device,
wherein the controller is configured to control the display to display a message inquiring whether to register the non-registered mobile device if the number of times of connection to the display apparatus is equal to or greater than a preset value, and
wherein the controller is configured to verify the newly-registered mobile device if the non-registered mobile device is registered in response to the message.

20. The display apparatus of claim 18, wherein the controller is configured to determine whether there is a plurality of people present in the home where the display apparatus is located, and
wherein the controller is configured to control the display to display a message to inquire whether to share the at least one content with the plurality of people upon determining that there is the plurality of people present in the home where the display apparatus is located.
